(19) United States
(12) Patent Application Publication
(10) Pub. No.: US 2025/0061372 A1
(43) Pub. Date: Feb. 20, 2025

(54) SYSTEM FOR CONVERTING THE ENCODING OF DISCRETE QUBITS INTO CONTINUOUS QUBITS

(71) Applicants: SORBONNE UNIVERSITE, Paris (FR); CENTRE NATIONAL DE LA RECHERCHE SCIENTIFIQUE, PARIS (FR); ECOLE NORMALE SUPERIEURE, PARIS (FR)

(72) Inventors: Julien LAURAT, PARIS (FR); Tom DARRAS, PARIS (FR); Beate Elisabeth ASENBECK, Paris (FR); Giovanni GUCCIONE, Paris (FR); Adrien CAVAILLES, Paris (FR)

(21) Appl. No.: 18/721,849

(22) PCT Filed: Dec. 16, 2022
(86) PCT No.: PCT/EP2022/086469

§ 371 Date: Jun. 19, 2024

(30) Foreign Application Priority Data
Dec. 21, 2021 (FR) FR2114170

(51) Int. Cl. G06N 10/80

(52) U.S. Cl. CPC G06N 10/80

(57) ABSTRACT

A system (1, 1′, 1″) for converting the encoding of qubits encoded as a discrete variable into qubits encoded as a continuous variable includes a first and a second compressed blank state source (3, 5) configured to generate a respectively single-mode and dual-mode compressed blank state. A first and a second beam splitter (7, 9) are arranged to receive respectively photons from the first and second sources. A third and a fourth beam splitter (11, 13) are configured to mix the photon states respectively of the conditioning paths of the first and second sources, and of the qubit encoded as a discrete variable and of the signal path of the second source. A first and a second detector (15) are arranged at the output respectively of the third and of the fourth beam splitter, the second detector being a photon counter.

### TECHNICAL FIELD

The present invention relates to the field of quantum information. It relates more specifically to a system for converting the encoding of quantum bits of discrete quantum variables into continuous quantum variables, making it possible to implement quantum interconnections between heterogeneous systems.

### PRIOR ART

Quantum information techniques have developed following two traditionally separate approaches: an approach based on quantum bits, or qubits, which are encoded as discrete variables and an approach based on qubits which are encoded as continuous variables.

Encoding as a discrete variable relies on using observables the eigenvalues of which may take discrete values.

Discrete qubits may, for example, be encoded on the spin of an electron, the polarization of a photon, the presence or the absence of a particle or indeed on a time bin. This last possibility consists in creating a superposition state of a particle by leaving it the possibility of passing along two optical paths of different lengths, thus creating a coherent superposition of the two quantum states of the particle.

Encoding as a continuous variable relies on using observables the eigenvalues of which may take continuous values.

Continuous qubits may, for example, be encoded by a superposition of coherent states of light. The tools and the concepts developed for these two types of variables are generally different and they cannot be used interchangeably. Thus, a device designed to manipulate discrete qubits will generally not be compatible with a device designed to manipulate continuous qubits.

By way of example, discrete qubits may be more easily stored in quantum memories, but the protocols for manipulating these qubits remain to date predominantly probabilistic. Continuous qubits make it possible, in contrast, to implement deterministic protocols such as the deterministic teleportation of a state, and may facilitate certain quantum computing functionalities. Various implementations of quantum computers are in the process of being carried out and also rely on different information encodings.

It is therefore particularly useful to be able to convert the encoding of a qubit between discrete variable and continuous variable in order to ensure compatibility between various items of quantum information equipment. This notably makes it possible to implement heterogeneous quantum networks comprising systems manipulating discrete qubits and systems manipulating continuous qubits.

The application US2005/254823 bears on a device for converting or for transferring quantum information encoded in the form of photons from a first photon state to a second photon state. Several embodiments of the device are disclosed.

The article “Entanglement and teleportation between polarization and wave-like encodings of an optical qubit”, Sychev et al, Nature Communications 9, 3672, 2018, describes an experimental device for teleporting a discrete qubit encoded as a polarization to a continuous qubit encoded on the basis of the superposition of coherent states.

In this device, the hybrid entangled state between the discrete qubit and the continuous qubit is created with a large contribution from the vacuum and may be removed only by a post-selection step. However, implementing a post-selection step is not acceptable for protocols for transferring unknown quantum states, since it is then not possible to determine which are the events which may be ignored.

The article “Engineering optical hybrid entanglement between discrete- and continuous-variable states”, Huang et al., New Journal of Physics 21, 083033, 2019, discloses a theoretical concept of hybrid entanglement between discrete and continuous qubits. However, no practical implementation is described.

There is therefore a need to propose a system for converting the encoding of discrete qubits into continuous qubits which improves the performance of existing devices, notably by eliminating resorting to a post-selection step and makes it possible to produce heterogeneous quantum links.

The aim of the invention is to at least partially meet this need.

### DISCLOSURE OF THE INVENTION

In order to do so, the invention relates to a system for converting the encoding of qubits encoded as a discrete variable into qubits encoded as a continuous variable, comprising:
an input path of a qubit encoded as a discrete variable,
a first squeezed vacuum state source, notably an optical parametric oscillator operated under the oscillation threshold, configured to generate a single-mode squeezed vacuum state,
a second squeezed vacuum state source, notably an optical parametric oscillator, configured to generate a two-mode squeezed vacuum state,
a first beam splitter arranged to receive photons from the first squeezed vacuum state source, a first output optical path of the first beam splitter constituting an output path of a qubit encoded as a continuous variable and a second output optical path of the first beam splitter constituting a conditioning path of the first squeezed vacuum state source,
a second, polarizing beam splitter arranged to receive photons from the second squeezed vacuum state source, a first output optical path of the second beam splitter constituting a conditioning path of the second squeezed vacuum state source and a second output optical path of the second beam splitter constituting a signal path of the second squeezed vacuum state source,
a third beam splitter arranged on the second output optical path of the first beam splitter and on the first output optical path of the second beam splitter, configured to mix photon states of the conditioning path of the first squeezed vacuum state source and of the conditioning path of the second squeezed vacuum state source,
a fourth beam splitter arranged on an optical path of the qubit encoded as a discrete variable and on the second output optical path of the second beam splitter, configured to mix photon states of the qubit encoded as a discrete variable and of the signal path of the second squeezed vacuum state source,
a first photon detector arranged on a first output optical path of the third beam splitter,
a second photon detector arranged on a first output optical path of the fourth beam splitter, the second photon detector being a photon counter.

The invention makes it possible to carry out a hybrid teleportation between a continuous variable and a discrete variable. This is achieved by mixing the complementary modes of the first and second squeezed vacuum state sources, this creating a hybrid entanglement, and by mixing an input discrete qubit with the discrete mode of the hybrid entanglement state. A Bell measurement is performed by the photon counter, this heralding the success of the conversion. Thus, the invention makes possible a conversion of the encoding of qubits which needs no post-selection step.

The beam splitter is, for example, a semi-reflective mirror.

In the context of the invention, a squeezed vacuum state source is a device having non-linear properties making it possible to generate squeezed vacuum states, notably single- or two-mode squeezed vacuum states. A squeezed vacuum state source is, for example, a single-pass non-linear crystal, notably an optical parametric amplifier (OPA), a non-linear crystal arranged in a cavity, notably an optical parametric oscillator (OPO), an optical fiber having third-order non-linearities which are obtained, for example, through the Kerr effect or four-wave mixtures, or indeed an atomic system making light-matter interactions such as hot vapors or clouds of atoms possible.

According to one preferred embodiment, the system comprises a fourth photon detector arranged on a second output optical path of the fourth beam splitter.

Preferably, the fourth photon detector is a photon counter.

The fourth photon detector may be used to carry out a phase lock or, when it is composed of a photon counter, to carry out a Bell measurement.

If the fourth detector is used to carry out a Bell measurement, an additional beam splitter is preferably arranged between the fourth splitter and the third detector or between the fourth splitter and the fourth detector, one of the output paths of the additional beam splitter being directed toward an additional photon detector, such as a photodiode, making it possible to carry out a phase lock.

Advantageously, the system comprises a third photon detector arranged on a second output optical path of the third beam splitter.

The third photon detector may be used to carry out a phase lock or to prepare a hybrid entanglement state with an opposite phase to the state prepared by the first photon detector.

If the third detector is not used to carry out a phase lock, an additional beam splitter is preferably arranged between the third splitter and the first detector or between the third splitter and the third detector, one of the output paths of the additional beam splitter being directed toward an additional photon detector, such as a photodiode, making it possible to carry out a phase lock.

According to one particular embodiment, the system comprises a device configured to apply a displacement operator, arranged between the second beam splitter and the third beam splitter.

According to one variant, the system further comprises:
a third squeezed vacuum state source, notably an optical parametric oscillator under the oscillation threshold, configured to generate a two-mode squeezed vacuum state, the second beam splitter being arranged to receive photons from the second and from the third squeezed vacuum state sources,
a fifth, polarizing beam splitter arranged between the first photon detector and the third beam splitter so that the first photon detector is arranged on a first output optical path of the fifth beam splitter,
a sixth, polarizing beam splitter arranged between the third photon detector and the third beam splitter so that the third photon detector is arranged on a first output optical path of the sixth beam splitter,
a fifth photon detector arranged on a second output optical path of the fifth beam splitter and a sixth photon detector arranged on a second output optical path of the sixth beam splitter.

This configuration advantageously makes it possible to convert the encoding of discrete qubits encoded as a polarization into continuous qubits.

Alternatively, the system further comprises:
a first delay loop arranged between the first and the third beam splitter,
a second delay loop arranged between the second and the third beam splitter,
a third delay loop arranged between the second and the fourth beam splitter.

This configuration advantageously makes it possible to convert discrete qubits encoded on a time bin into continuous qubits.

Preferably, the system then comprises an input path of a vacuum state connected to an input of the first delay loop and a second displacement device arranged on the input path of a vacuum state and configured to apply a displacement operator to the vacuum state.

Advantageously, the second photon detector comprises a seventh beam splitter, a superconducting nanowire single-photon detector (SNSPD) arranged on a first output optical path of the seventh beam splitter and a homodyne detector arranged on a second output optical path of the seventh beam splitter.

This feature improves the Bell measurement.

The invention also bears on a conversion assembly comprising a conversion system according to the invention and a system for creating a qubit encoded as a discrete variable, the creation system being configured to transmit a qubit encoded as a discrete variable to the conversion system via the input path of a qubit.

The invention also bears on a method for converting the encoding of a qubit encoded as a discrete variable into a qubit encoded as a continuous variable, notably implemented by a system according to the invention as defined above, comprising the steps consisting in:
providing an input photonic qubit encoded as a discrete variable;
carrying out a hybrid entanglement between a discrete mode and a continuous mode;
carrying out a mixture of the input qubit with the discrete mode of the hybrid entanglement;
carrying out a Bell measurement of the mixture by detecting individual photons;
obtaining an output qubit encoded as a continuous variable from the continuous mode of the hybrid entanglement.

Preferably, the step of carrying out the hybrid entanglement between the discrete mode and the continuous mode comprises the actions consisting in:
providing a single-mode squeezed vacuum state of light, constituting the continuous mode, and a two-mode squeezed vacuum state of light, constituting the discrete mode;
carrying out a hybrid entanglement by mixing a conditioning path of discrete states which originate from the two-mode squeezed vacuum state and a conditioning path of continuous states which originate from the single-mode squeezed vacuum state.

The squeezed mode and the two-mode squeezed state are preferably each generated by a squeezed vacuum state source, such as an optical parametric oscillator, an optical parametric amplifier, an optical fiber or an atomic system.

The Bell measurement is preferably carried out by a photon counter comprising a beam splitter, an SNSPD arranged on a first output optical path of the beam splitter and a homodyne detector arranged on a second output optical path of the beam splitter.

### BRIEF DESCRIPTION OF THE DRAWINGS

FIG. 1 schematically depicts a system according to the invention configured to convert a qubit encoded as a discrete variable on the basis of Fock into a qubit encoded as a continuous variable.

FIG. 2 schematically depicts a system according to the invention configured to convert a discrete qubit encoded as a polarization into a qubit encoded as a continuous variable.

FIG. 3 schematically depicts a system according to the invention configured to convert a discrete qubit encoded on a time bin into a qubit encoded as a continuous variable.

FIG. 4 is a detailed view of a delay loop as used in the system of FIG. 3.

FIG. 5 illustrates a system according to the invention associated with a system for creating a discrete qubit encoded on the basis of Fock.

### DETAILED DESCRIPTION

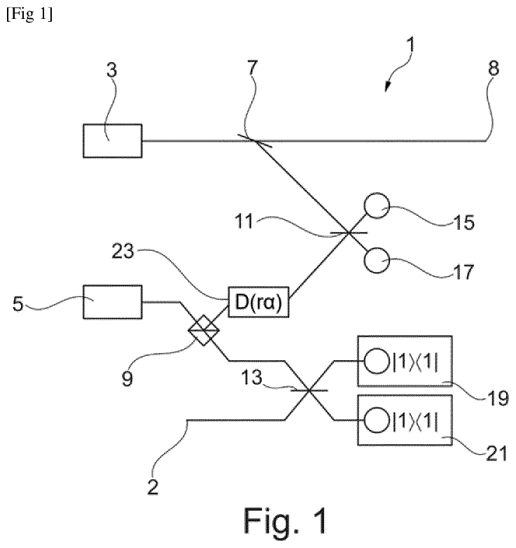

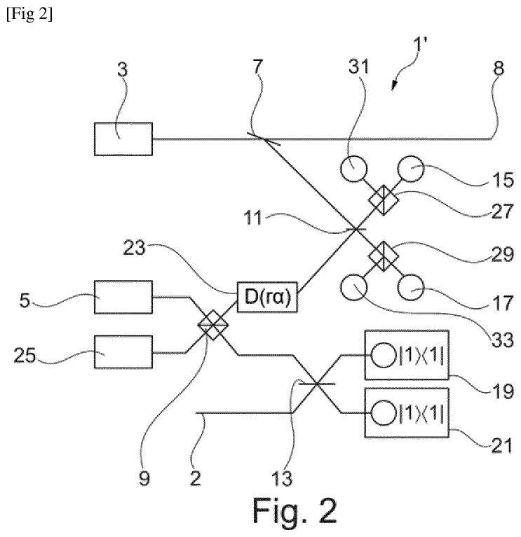

FIG. 1 schematically illustrates a system 1 according to the invention configured to convert a discrete qubit encoded on the basis of Fock {|0>, |1>}, in other words encoded on the presence |1> or the absence |0> of a single photon, into a continuous qubit encoded on the basis of the superposition of coherent states {|cat+>, |cat−>} such that |cat±∝|α>±|−α>, where |α> and |−α> are coherent states of amplitude |α|.

The input qubit is encoded as a discrete variable (DV) on the basis of Fock and therefore has the form:

$${\vert φ 〉}_{DV} = {c}_{0} \vert 0 〉 + {c}_{1} {e}^{i θ} \vert 1 〉 \qquad [ Math 1 ]$$

c₀ and c₁e^{iθ} are coefficients which represent information encoded on the input qubit.

The output qubit is encoded as a continuous variable (CV) and takes the form:

$${\vert φ 〉}_{CV} = {c}_{0} \vert cat + 〉 \pm {c}_{1} {e}^{i θ} \vert cat - 〉 \qquad [ Math 2 ]$$

Thus, the system 1 transfers the information carried by the input qubit, encoded as a discrete variable, to the output qubit, encoded as a continuous variable. The information is represented by the coefficients c₀ and c₁e^{iθ}.

The + or − sign in the equation [Math 2] depends on the detector used to carry out the teleportation.

The system 1 comprises a first squeezed vacuum state source 3, in this example an optical parametric oscillator (OPO) operated under the oscillation threshold and configured to generate a single-mode squeezed vacuum state of light, and a second squeezed vacuum state source 5, in this example an optical parametric oscillator operated under the oscillation threshold configured to generate a two-mode squeezed vacuum state of light.

Preferably, a photon subtraction is carried out on the single-mode squeezed vacuum state generated by the first OPO 3. The subtraction of a photon is carried out by extracting a fraction of the beam from the squeezed vacuum state. This extracted fraction is directed toward a photon detector. The detection of a photon on this photon detector heralds the creation of the squeezed vacuum state with subtraction of a photon.

A squeezed state of light is a mode which, for some of its quadrature components, has reduced quantum uncertainty with respect to a coherent state.

The squeezed mode generated by the first OPO 3 is directed toward a first beam splitter 7. A first output optical path of the first splitter 7 constitutes an output path 8 for the qubit encoded as a continuous variable. A second output optical path of the first splitter 7 constitutes a conditioning path of the continuous mode of the hybrid entanglement.

The amplitude reflection coefficient of the first splitter, labelled r, is preferably such that r² is less than or equal to 0.1, more preferably less than or equal to 0.05, for example equal to 0.03. Thus, a fraction (1−r²) of an incident beam is transmitted to the output optical path of the first splitter 3 constituting the output path and a fraction r² of an incident beam is reflected toward the conditioning path and toward the third beam splitter 11.

The two-mode squeezed vacuum state generated by the second OPO 5 is directed toward a second beam splitter 9.

A two-mode squeezed vacuum state may be considered to be a superposition of correlated Fock states, notably at a low pump power of the pairs of photons entangled in orthogonal polarizations. The splitter 9 is polarizing in order to separate the two photons corresponding to two Fock states according to their vertical or horizontal polarization.

A third beam splitter 11 is arranged on the second output optical path of the first splitter 7 and on a first output optical path of the second splitter 9, constituting a conditioning path of the discrete mode.

Optionally, a device 23 configured to apply a displacement operator is arranged between the second beam splitter 9 and the third beam splitter 11.

The device 23 comprises a partially reflective beam splitter configured to mix a mode to be displaced with an attenuated coherent state with a corresponding amplitude r1|α|.

The displacement operator applied is:

$$\hat{D} ( r 1 α ) = exp ( r 1 α {\hat{a}}^{†} - r 1 {α}^{*} \hat{a} ) \qquad [ Math 3 ]$$

r1 represents the amplitude reflection coefficient of the beam splitter of the device 23, |α| is the amplitude of the mode prepared by the first OPO 3, â and â^{†} are the photon annihilation and creation operators, respectively.

When the amplitude |α| of the coherent state which originates from the first OPO is non-calibrated, r1 is preferably adjusted so that the amplitude r1|α| corresponds to the amplitude of light in the conditioning path of the first OPO 3.

Advantageously, applying this displacement makes it possible to improve the conversion protocol. Specifically, the displacement on the conditioning path of the discrete mode at the output of the second splitter 9 makes it possible to balance the average number of photons which originate from the second OPO 5 with the average number of photons which originate from the first splitter 7, this maximizing indistinguishability at the third splitter 11.

Indistinguishability is optimal when r1 is equal to the amplitude reflection coefficient r of the first beam splitter 7.

A first photon detector 15 and, optionally, a third photon detector 17 are arranged on the two output optical paths of the third splitter 11.

Thus, the third splitter 11 is configured to mix a photon which originates from the OPO 3 (continuous mode) and a photon which originates from the OPO 5 (discrete mode). In other words, conditioning paths of the two OPOs 3, 5 are combined at the third splitter.

Preferably, the first OPO 3 produces a squeezed vacuum state with noise reduction of 5 dB or less, more preferably 3 dB or less.

The arrival of a photon on the first detector 15 corresponds to one of two states which cannot be distinguished from one another, because of the mixture performed by the third splitter.

For example, if there is generated a vacuum state with photon subtraction from the squeezed vacuum state generated by the first OPO 3, the two states which cannot be distinguished are the following: either the photon detected comes from the second OPO 5, in which case a squeezed vacuum state was present at the output of the first OPO 3 on the output path 8 and a single photon was present at the output of the second OPO 5, or the photon detected comes from the first OPO 3, in which case a vacuum state was present at the output of the second OPO 5 and a squeezed vacuum state with photon subtraction was present on the output path 8 of the first OPO 3.

The detection of a photon on the first detector 15 heralds the creation of a hybrid entanglement state of the form |0>|cat+>+|1>|cat−>.

The third detector 17 may advantageously be used to carry out a phase lock.

The third detector 17 may also herald the preparation of an entangled state with a phase opposite to that of the entangled state heralded by the first detector 15, that is to say a state of the form |0>|cat+>−|1>|cat−>.

If the third detector is not used to carry out a phase lock, an additional beam splitter is preferably arranged between the third splitter 11 and the first detector 15 or between the third splitter 11 and the third detector 17, one of the output paths of the additional beam splitter being directed toward an additional photon detector, such as a photodiode, making it possible to carry out a phase lock.

A phase lock is, for example, carried out by interferometry. The amplitude of an interference pattern is measured on a photon detector, a control loop making it possible to remain on a peak of the pattern over the length of the optical path, for example with the aid of a piezoelectric actuator.

The system 1 also comprises an input path 2 for a qubit encoded as a discrete variable.

A fourth beam splitter 13 is arranged on a second output optical path of the second splitter 9 and on the optical path of the input path 2. Preferably, the fourth splitter 13 and/or the second splitter 9 and/or the third splitter 11 is a splitter transmitting 50% of the light received and reflecting 50% of the light received.

Thus, the fourth splitter 13 makes it possible to mix the input qubit with the discrete mode which originates from the second OPO 5.

A second photon detector 19 and, optionally, a fourth photon detector 21 are each arranged on one of the two output optical paths of the fourth splitter 13.

The second detector 19 is a photon counter.

Counting the photons individually carries out a Bell state measurement. The Bell state measurement makes it possible to teleport the information carried by the input qubit to the output qubit.

Thus, the detection of a photon on the second detector 19 heralds the state:

$${\vert φ 〉}_{CV} = {c}_{0} \vert cat + 〉 + {c}_{1} {e}^{i θ} \vert cat - 〉 \qquad [ Math 4 ]$$

The Bell measurement may be implemented in various ways.

The photon counter is thus, for example, a superconducting nanowire single-photon detector (SNSPD). An SNSPD achieves high quantum efficiency. However, it generally does not make it possible to distinguish single-photon components from multi-photon components. This is liable to degrade the quality of the teleportation.

It is therefore preferable to couple an SNSPD with homodyne detection.

Optical homodyne detection measures interference between a signal and a reference beam, the signal and the reference having a relative phase between them. Homodyne detection makes it possible to measure a quadrature component of the electric field.

In the context of the invention, homodyne detection may be used as a parity detector.

By combining an SNSPD with homodyne detection, it is possible to confirm that a single photon is detected, this advantageously improving the Bell measurement. In order to carry out this combination, the photon counter comprises a beam splitter, preferably having an amplitude reflection coefficient r2 such that r2² is less than or equal to 0.1, more preferably less than or equal to 0.05, for example equal to 0.03. A first optical output of this splitter, corresponding to the reflected fraction r2² of the beam, is directed toward an SNSPD and the other optical output, corresponding to the transmitted fraction (1-r2²) of the beam, is directed toward a homodyne detector.

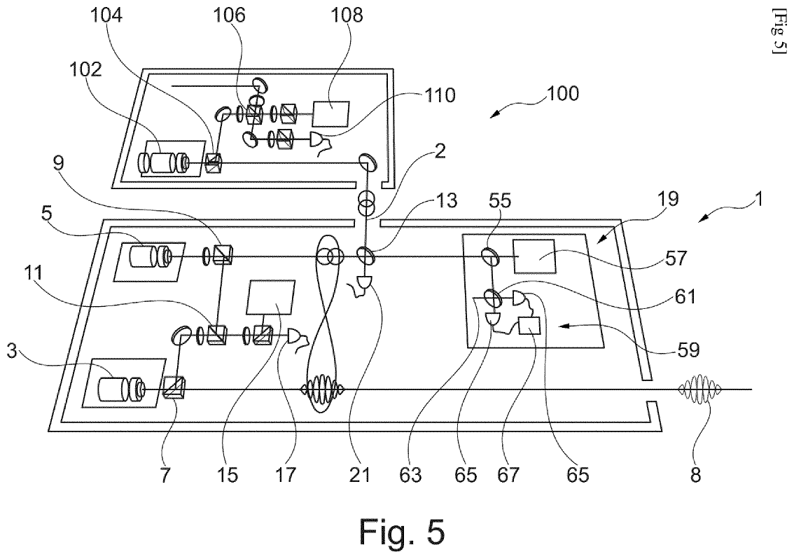

One example of such a photon counter 19 is illustrated in FIG. 5.

In order to perform the Bell measurement, it must be possible to distinguish between the events consisting of the absence of a photon, the presence of a photon or the presence of two photons at the photon counter. A detection by the SNSPD makes it possible to exclude the case of the absence of a photon. Using a beam splitter transmitting a small fraction of a beam to the homodyne detector, a detection by the SNSPD means either that a photon is directed toward the homodyne detector in the case of the initial presence of two photons, or that no photon is directed toward the homodyne detector in the case of the initial presence of a single photon. The homodyne detector makes it possible to discriminate between the presence and the absence of a photon and therefore to determine whether a single photon has entered the photon counter. Alternatively, the photon counter may be a photon number resolving detector (PNRD). A detector of this type is capable of distinguishing the number of incident photons.

In the example illustrated in FIG. 1, the second and fourth detectors 19, 21 are both photon counters.

A detection on the fourth photon detector 21 heralds the following state, which has a relative phase difference with a value of π from the state heralded by the second detector 19:

$${\vert φ 〉}_{CV} = {c}_{0} \vert cat + 〉 - {c}_{1} {e}^{i θ} \vert cat - 〉 \qquad [ Math 5 ]$$

This state has an opposite phase to the state heralded by a detection on the second photon detector 19. In other words, this amounts to applying the Pauli operator σ_{Z} to the state heralded by the second detector 19.

It is, however, possible to compensate for this phase difference in order to systematically create a state of the same phase. The compensation is, for example, carried out by an adjustable phase retardation plate arranged on the output path 8 depending on a possible detection event on the third and fourth detectors 19 and 21.

Alternatively, the fourth detector 21 is not a photon counter and it is configured to carry out a phase lock. This may notably be carried out if the fourth detector 21 is a photodiode.

If the fourth detector is not used to carry out a phase lock, an additional beam splitter is preferably arranged between the fourth splitter 13 and the third detector 19 or between the fourth splitter 13 and the fourth detector 21, one of the output paths of the additional beam splitter being directed toward an additional photon detector, such as a photodiode, making it possible to carry out a phase lock.

Advantageously, an interference filter and/or a Fabry-Perot cavity are arranged in front of the input of one or more of the photon detectors, in particular in front of the first and/or in front of the second photon detector.

FIG. 1 schematically illustrates a system 1′ according to the invention configured to convert the encoding of a discrete qubit encoded as a polarization on the basis {|H>, |V>}, in other words encoded on the horizontal polarization |H> or vertical polarization |V> of a photon, into a continuous qubit encoded on the basis of the superposition of coherent states {|α>, |−α>}.

The elements which are identical to those of the embodiment of FIG. 1 and fulfill the same functions are identified by the same reference signs.

The input qubit is encoded as a discrete variable (DV) and has the form:

$${\vert φ 〉}_{DV} = {c}_{0} \vert H 〉 + {c}_{1} {e}^{i θ} \vert V 〉 \qquad [ Math 6 ]$$

c₀ and c₁e^{iθ} are coefficients which represent information encoded on the input qubit.

The output qubit is encoded as a continuous variable (CV) and takes the form:

$${\vert φ 〉}_{CV} = {c}_{0} \vert α 〉 \pm {c}_{1} {e}^{i θ} \vert - α 〉 \qquad [ Math 7 ]$$

Thus, the system 1′ transfers the information carried by the input qubit, encoded as a discrete variable, to the output qubit, encoded as a continuous variable.

Unlike the system 1 illustrated in FIG. 1, the system 1′ comprises a third optical parametric oscillator 25. The third OPO 25 is configured to generate a two-mode squeezed vacuum state of light, like the second OPO 5. The field generated by the third OPO 25 is directed toward the second beam splitter 9.

Thus, the photon states at the output of the second and third OPOs are mixed at the second beam splitter 9.

Using two OPOs 5, 25 makes it possible to herald the hybrid entangled state, which requires a double detection in the case of an encoding as a polarization. In this example, the discrete mode of the hybrid entanglement is encoded as a polarization.

The detection of the polarization state of a photon at the output of the third beam splitter 11 requires the implementation, on each of the two output optical paths of the third splitter, of a polarizing beam splitter 27, 29. Each of the polarizing splitters 27, 29 directs photons depending on their polarization state |H> or |V> toward two detectors, 15, 31 and 17, 33, respectively, which are arranged so as to detect photons at the output of the two polarizing splitters 27, 29.

The detectors 15, 17, 31, 33 are photon counters such as SNSPDs.

A hybrid entanglement state is heralded when a photon in the state |H> is detected at the output of the splitter 27 and a photon in the state |V> is detected at the output of the splitter 29, or conversely when a photon in the state |V> is detected at the output of the splitter 27 and a photon in the state |H> is detected at the output of the splitter 29.

Depending on the detection mode, there is a relative phase difference with a value of π between the states heralded. The hybrid entanglement state heralded thus has the form |H>|α>+|V>|−α> in the first case, and |H>|α>−|V>|−α> in the second case.

Just as in the embodiment of FIG. 1, the displacement device 23 and the fourth photon detector 21 are optional.

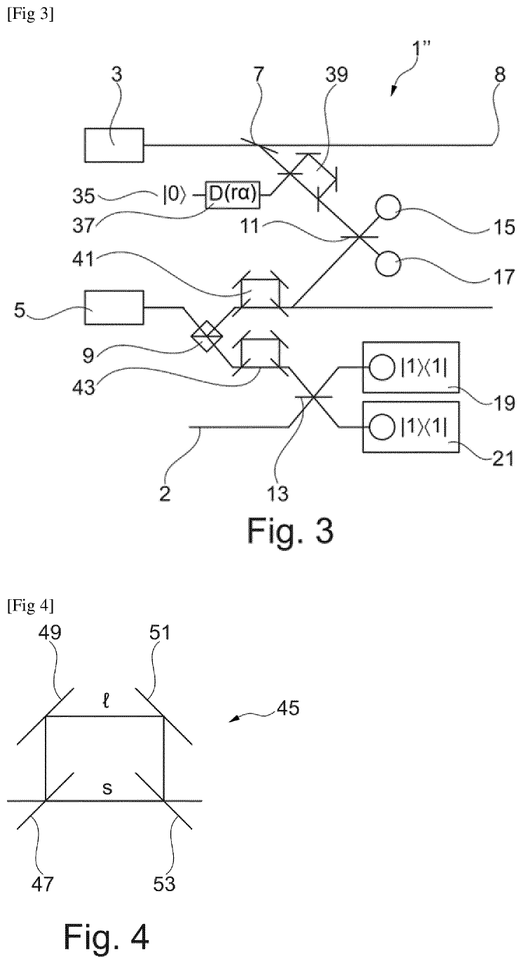

FIG. 3 schematically illustrates a system 1″ according to the invention configured to convert the encoding of a discrete qubit encoded on a time bin on the basis {|s>, |1>} into a continuous qubit encoded on the basis of the superposition of coherent states {|α>, |−α>}. In the example illustrated, the discrete qubit is encoded on a short distance |s> or long distance |1> traveled by a photon.

The elements which are identical to those of the embodiment of FIG. 1 and carry out the same functions are identified by the same reference signs.

The input qubit is encoded as a discrete variable (DV) and has the form:

$${\vert φ 〉}_{DV} = {c}_{0} \vert s 〉 + {c}_{1} {e}^{i θ} \vert l 〉 \qquad [ Math 8 ]$$

c₀ and c₁e^{iθ} are coefficients which represent information encoded on the input qubit.

The output qubit is encoded as a continuous variable (CV) and takes the form:

$${\vert φ 〉}_{CV} = {c}_{0} \vert α 〉 \pm {c}_{1} {e}^{i θ} \vert - α 〉 \qquad [ Math 7 ]$$

Thus, the system 1″ transfers the information carried by the input qubit, encoded as a discrete variable, to the output qubit, encoded as a continuous variable.

Unlike the embodiment of FIG. 1, the system 1″ comprises several delay loops. The delay loops make it possible to generate the states |s> and |1> of the photons. A delay loop preferably comprises two beam splitters and two mirrors, arranged so as to create a first optical path s and a second optical path 1 which is longer than the path s.

One example of a delay loop 45 is illustrated in FIG. 4. The delay loop 45 comprises a beam splitter 47, one of the output optical paths of which is directed toward the beam splitter 53 and the other output optical path of which is directed successively toward the mirror 49, the mirror 51 then the splitter 53.

Thus, a first optical path of the delay loop 45, called s, consists in passing directly from the splitter 47 to the splitter 51. A second optical path of the delay loop, called 1, consists in passing from the splitter 47 to the mirrors 49, 51 and finally to the splitter 53.

The system 1″ comprises a first delay loop 39 arranged between the first beam splitter 7 and the third beam splitter 11.

The system 1″ also comprises an input path 35 of a vacuum state directed toward the input beam splitter of the first delay loop 39. The input path 35 provides a conditioning path of the CV mode.

Optionally, a displacement device 37 configured to execute a displacement D(rα) on the vacuum state is placed between the input path 35 and the first delay loop 39, where r represents the amplitude reflection coefficient of a beam splitter of the device 37 and |α| represents the amplitude of the state of the input path 35, which notably depends on the compression performed by the first OPO 3. The displacement device 37 may advantageously improve the conversion by making it possible to balance the amplitude of the squeezed vacuum state with the fraction of light extracted from the first OPO 3 by the first splitter 7, this making it possible to maximize the interference at the delay line. Preferably, the coefficient r of the beam splitter of the device 37 is equal to the coefficient r of the first splitter 7 in order to maximize this effect.

A second delay loop 41 and a third delay loop 43 are arranged between the second beam splitter 9 and the third beam splitter 11, and between the second splitter 9 and the fourth splitter 13, respectively.

Thus, the delay loops 39, 41, 43 make it possible to create modes |s> or |1> on the various beams.

As in the embodiment of FIG. 1, a detection on the first photon detector 15 heralds the creation of an entangled hybrid state of the form |s>|α>+|1>|1−α>. A detection on the third, optional photon detector 17 heralds the creation of a state with an opposite phase, that is to say a state of the form |s>|α>−|1>|1−α>.

The second and fourth photon detectors 19, 21 may both be photon counters. Alternatively, only the second detector 19 is a photon counter. The fourth, optional detector 21 may also be a photodiode used to carry out a phase lock.

### Example

FIG. 5 depicts one embodiment of a system 1 according to the invention associated with a system 100 for creating a qubit encoded as a discrete variable.

The elements which are identical to those of the embodiment of FIG. 1 and carry out the same functions are identified by the same reference signs.

The system 1 is configured to convert a qubit encoded as a discrete variable on the basis of Fock entering via the input path 2 into a qubit encoded as a continuous variable exiting via the output path 8.

The qubit encoded as a discrete variable is generated by the system 100.

The system 100 comprises an optical parametric oscillator 102 configured to generate a two-mode squeezed vacuum state of light. The OPO 102 may generate single photons. The optical output of the OPO 102 is directed toward a polarizing beam splitter 104. A first output optical path of the splitter 104 is directed toward the input path 2 of the conversion system 1, the other output optical path is directed toward the beam splitter 106.

In order to generate the discrete qubit, a displacement is applied to the heralding mode of a photon generated by the OPO 102, this rendering the heralding and displacement modes of the photon indistinguishable. The creation of the qubit is heralded by a detection on the SNSPD 108. The photodiode 110 makes it possible to control the phase lock θ.

The discrete qubit generated has the form:

$${\vert φ 〉}_{DV} = {c}_{0} \vert 0 〉 + {c}_{1} {e}^{i θ} \vert 1 〉 \qquad [ Math 1 ]$$

The coefficients c₀ and c₁e^{iθ} are determined by the amplitude and the phase of the displacement of the heralding mode of the photon generated by the OPO 102.

In this example, the first photon detector 15 is an SNSPD and the third photon detector 17 is a photodiode configured to regulate the phase lock.

The second photon detector 19 of the conversion system 1 is a photon counter comprising an SNSPD combined with a homodyne detector.

Thus, the second detector 19 first of all comprises a beam splitter 55. A first output optical path of the splitter 55 is directed toward an SNSPD 57 and the other output optical path is directed toward a homodyne detector 59.

The homodyne detector 59 comprises a beam splitter 61. An input path 63 of a reference beam is directed toward the splitter 61. The mixture of the signal and the reference beam is sent to two photon detectors 65, preferably photodiodes, which are connected to a device 67 which makes it possible to carry out the homodyne measurement. The device 67 is, for example, configured to subtract the currents produced by the two photon detectors 65.

The fourth photon detector 21 is a photodiode configured to carry out a phase lock.

Thus, the hybrid entanglement is prepared by projecting the conditioning paths of the OPOs 3 and 5 by an heralding on the first SNSPD 15. This makes it possible to mix the input discrete qubit with the discrete mode of the hybrid entanglement.

The Bell measurement is heralded by a detection on the SNSPD 57 of the second detector 19 followed by a conditioning on the homodyne detection assembly 59.

The conversion of the qubit is heralded by simultaneous detection on the two SNSPDs 15 and 57.

In the example of FIG. 5, the OPOs 3, 5, 102 are configured to have a passband of around 50 MHz and a free spectral range of 4.3 GHz. The pump power is below the oscillation threshold.

The pump light is produced by a continuous laser with a wavelength of 532 nm. The OPOs 3, 5, 102 each produce a signal wave and an idler wave at a wavelength of 1064 nm.

The first and the second OPOs 3, 5 comprise a linear semi-monolithic cavity. The input mirrors are deposited directly onto the crystal of the OPO. The output mirrors have a radius of curvature of 38 mm.

The first OPO 3 comprises a type I periodically poled potassium titanyl phosphate (PPKTP) crystal, as supplied by Raicol, subjected to a pump power of 15 mW with a noise compression of 4.5 dB. 7% of the beam produced is extracted in order to create a squeezed vacuum state with photon subtraction. The first OPO 3 is doubly resonant, the double resonance being obtained by adjusting the length of the cavity and the temperature of the PPKTP crystal.

The second OPO 5 comprises a type II potassium titanyl phosphate (KTP) crystal, as supplied by Raicol, subjected to a pump power of 3.5 mW. The OPO 5 is triply resonant, the triple resonance being obtained by adjusting the length of the cavity, the temperature of the crystal and the wavelength of the pump laser.

The OPO 102 comprises a type II KTP crystal subjected to a pump power of 2 mW. In order to obtain a simultaneous triple resonance of the OPOs 5 and 102, the angle of the crystal of the OPO 102 constitutes an additional degree of freedom. To this end, the input mirror of the OPO 102 is free and not deposited onto the crystal, in contrast to the OPO 105.

The SNSPDs 15, 57, 108 are implemented at a temperature of 1.3 K. Before the input of each SNSPD an interference filter with a passband of 125 GHz and a Fabry-Perot cavity with a free spectral range of 330 GHz and with a passband of 320 MHz are arranged in order to filter the heralding photons.

The three SNSPDs 15, 57, 108 must each herald an event in the same time bin in order to herald the success of the teleportation of the discrete qubit to the continuous qubit. An ultra-fast detection module is used to analyze this triple detection, such as the ID 900 Time Controller module from ID Quantique.

Other variants and improvements may be provided without, however, departing from the scope of the invention.

1. A system for converting the encoding of qubits encoded as a discrete variable into qubits encoded as a continuous variable, comprising:
an input path of a qubit encoded as a discrete variable,
a first squeezed vacuum state source configured to generate a single-mode squeezed vacuum state,
a second squeezed vacuum state source configured to generate a two-mode squeezed vacuum state,
a first beam splitter arranged to receive photons from the first squeezed vacuum state source, a first output optical path of the first beam splitter constituting an output path of a qubit encoded as a continuous variable and a second output optical path constituting a conditioning path of the first squeezed vacuum state source,
a second, polarizing beam splitter arranged to receive photons from the second squeezed vacuum state source, a first output optical path of the second beam splitter constituting a conditioning path of the second squeezed vacuum state source and a second output optical path constituting a signal path of the second squeezed vacuum state source,
a third beam splitter arranged on the second output optical path of the first beam splitter and on the first output optical path of the second beam splitter, configured to mix photon states of the conditioning path of the first squeezed vacuum state source and of the conditioning path of the second squeezed vacuum state source,
a fourth beam splitter arranged on an optical path of the qubit encoded as a discrete variable and on the second output optical path of the second beam splitter, configured to mix photon states of the qubit encoded as a discrete variable and of the signal path of the second squeezed vacuum state source,
a first photon detector arranged on a first output optical path of the third beam splitter,
a second photon detector arranged on a first output optical path of the fourth beam splitter, the second photon detector being a photon counter,
the system further comprising a third photon detector on a second output optical path of the third beam splitter and a fourth photon detector arranged on a second output optical path of the fourth beam splitter.

2. The system as claimed in claim 1, the fourth photon detector being a photon counter.

3. The system as claimed in claim 1, comprising a device configured to apply a displacement operator arranged between the second beam splitter and the third beam splitter.

4. The system as claimed in claim 1, further comprising:
a third squeezed vacuum state source configured to generate a two-mode squeezed vacuum state, the second beam splitter being arranged to receive photons from the second and from the third squeezed vacuum state sources,
a fifth, polarizing beam splitter arranged between the first photon detector and the third beam splitter so that the first photon detector is arranged on a first output optical path of the fifth beam splitter,
a sixth, polarizing beam splitter arranged between the third photon detector and the third beam splitter so that the third photon detector is arranged on a first output optical path of the sixth beam splitter,
a fifth photon detector arranged on a second output optical path of the fifth beam splitter and a sixth photon detector arranged on a second output optical path of the sixth beam splitter.

5. The system as claimed in claim 1, further comprising:
a first delay loop arranged between the first and the third beam splitter,
a second delay loop arranged between the second and the third beam splitter,
a third delay loop arranged between the second and the fourth beam splitter.

6. The system as claimed in claim 5, comprising an input path of a vacuum state connected to an input of the first delay loop and a second displacement device arranged on the input path of a vacuum state and configured to apply a displacement operator to the vacuum state.

7. The system as claimed in claim 1, the second photon detector comprising a seventh beam splitter, an SNSPD arranged on a first output optical path of the seventh beam splitter and a homodyne detector arranged on a second output optical path of the seventh beam splitter.

8. A conversion assembly comprising a conversion system as claimed in claim 1 and a system for creating a qubit encoded as a discrete variable, the creation system being configured to transmit a qubit encoded as a discrete variable to the conversion system via the input path of a qubit.

9. A method for converting the encoding of a qubit encoded as a discrete variable into a qubit encoded as a continuous variable implemented by a system as claimed in claim 1, comprising:
providing an input photonic qubit encoded as a discrete variable;
carrying out a hybrid entanglement between a discrete mode and a continuous mode;
carrying out a mixture of the input qubit with the discrete mode of the hybrid entanglement;
carrying out a Bell measurement of the mixture by detecting individual photons;
obtaining an output qubit encoded as a continuous variable from the continuous mode of the hybrid entanglement.

10. The method as claimed in claim 9, the step of carrying out the hybrid entanglement between the discrete mode and the continuous mode comprising
providing a single-mode vacuum state of light, constituting the continuous mode, and a two-mode squeezed vacuum state of light, constituting the discrete mode;
carrying out a hybrid entanglement by mixing a conditioning path of discrete states which originate from the two-mode squeezed vacuum state and a conditioning path of continuous states which originate from the single-mode squeezed vacuum state.
